(19) United States
(12) Patent Application Publication
(10) Pub. No.: US 2024/0126202 A1
(43) Pub. Date: Apr. 18, 2024

(54) APPARATUS

(71) Applicant: FUJIFILM Business Innovation Corp., Tokyo (JP)

(72) Inventors: Akira TANAKA, Kanagawa (JP); Keigo Shinoto, Kanagawa (JP); Shuichi Nishide, Kanagawa (JP); Michiaki Yoshida, Kanagawa (JP); Akira Ueshima, Kanagawa (JP); Takahiro IIzuka, Kanagawa (JP); Wataru Nakamura, Kanagawa (JP)

(73) Assignee: FUJIFILM Business Innovation Corp., Tokyo (JP)

(21) Appl. No.: 18/300,361

(22) Filed: Apr. 13, 2023

(30) Foreign Application Priority Data
Oct. 13, 2022 (JP) 2022-164892

(51) Int. Cl. G03G 21/16; B41J 29/13

(52) U.S. Cl. CPC G03G 21/1633; B41J 29/13

(57) ABSTRACT

An apparatus includes a housing, a cover that is opened and closed on the housing, a detection part that detects opening and closing of the cover using ON and OFF, a rotating part that is rotatably supported and turns on and off the detection part, a pushing portion that comes into contact with the rotating part to rotate the rotating part in a case where the cover is closed, and a rotation applying part that applies a rotational force to the rotating part rotated by the pushing portion in a direction in which the detection part is turned on in a case where the cover is closed.

### CROSS-REFERENCE TO RELATED APPLICATIONS

This application is based on and claims priority under 35 USC 119 from Japanese Patent Application No. 2022-164892 filed Oct. 13, 2022.

### BACKGROUND

### (i) Technical Field

The present invention relates to an apparatus.

### (ii) Related Art

JP2011-138679A discloses a configuration that makes it difficult for a cover to receive a reaction force in a direction in which the cover is opened by making the direction of a force, which is received from the opening/closing switch in a case where the opening/closing cover is closed, faces a rotating shaft of the opening/closing cover, in order to make it difficult for a force of an opening/closing switch for a cover of an electric device to act as a force for opening the cover.

### SUMMARY

There is an apparatus that includes a cover to be opened and closed on a housing, and transmits a force caused by a pushing portion provided on the cover to be opened and closed and switches the ON and OFF of a detection part to detect an opening/closing state of the cover to be opened and closed. A force applied to the detection part by the pushing portion is not constant due to, for example, a deviation that is caused by a tolerance between the pushing portion and the detection part or an increase and reduction in a force that is applied by a user to close the cover. For this reason, a configuration where, for example, an elastic body, such as a compression spring or a leaf spring, is used to buffer an excessive force caused by the pushing portion is used so that an excessive force is not applied to the detection part from the pushing portion. In this case, since a reaction force is applied from the elastic body provided to prevent an excessive force from being applied to the detection part in a case where the opening/closing cover is opened and closed, the operability of the opening/closing cover is reduced.

Aspects of non-limiting embodiments of the present disclosure relate to an apparatus that suppresses a reduction in operability in a case where a cover is opened and closed as compared to a case where a force of a pushing portion is transmitted to a detection part and the detection part is turned on and off with the force of the pushing portion.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an apparatus including a housing, a cover that is opened and closed on the housing, a detection part that detects opening and closing of the cover using ON and OFF, a rotating part that is rotatably supported and turns on and off the detection part, a pushing portion that comes into contact with the rotating part to rotate the rotating part in a case where the cover is closed, and a rotation applying part that applies a rotational force to the rotating part rotated by the pushing portion in a direction in which the detection part is turned on in a case where the cover is closed.

### BRIEF DESCRIPTION OF THE DRAWINGS

Exemplary embodiment(s) of the present invention will be described in detail based on the following figures, wherein:

FIG. 1 is a diagram showing an image forming apparatus to which a present exemplary embodiment is applied;

FIG. 2 is a perspective view illustrating a detection unit and a pushing member;

FIG. 3 is a diagram of the detection unit and the pushing member shown in FIG. 2 as viewed from a right side to a left side in FIG. 2;

FIG. 4 is a schematic diagram showing a relationship between a detection part, a rotating part, a rotation applying part, and the pushing member;

FIG. 5 is a schematic diagram showing a relationship between the detection part, the rotating part, the rotation applying part, and the pushing member; and

FIG. 6 is a diagram illustrating an opening/closing detection mechanism in the related art.

### DETAILED DESCRIPTION

An exemplary embodiment of the present invention will be described in detail below with reference to the accompanying drawings.

First, the related art will be described with reference to the drawing prior to the description of the present exemplary embodiment.

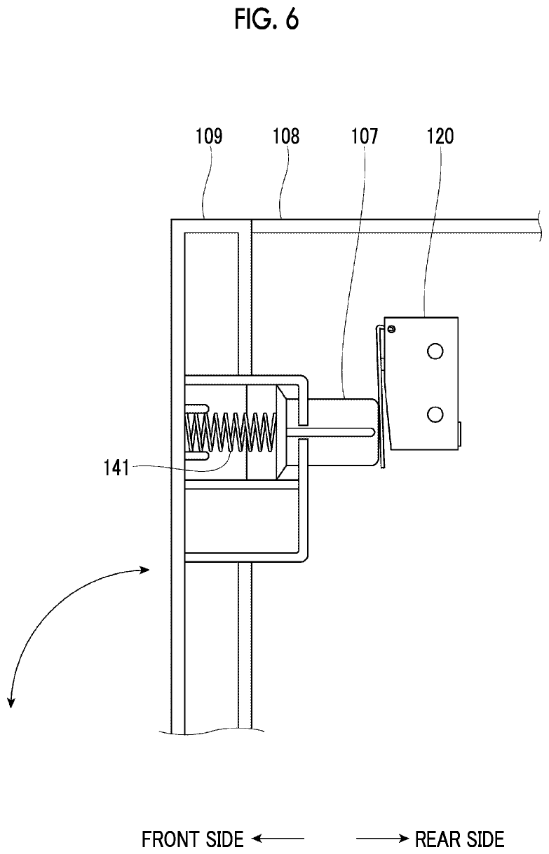

FIG. 6 is a diagram illustrating an opening/closing detection mechanism in the related art. FIG. 6 shows a state where a cover 109 is closed on a housing 108.

The housing 108 includes a detection part 120. The detection part 120 is formed of an interlock switch that detects the push of a push button using the movement of the push button in a case where a lever is pushed. The cover 109 includes a pushing member 107.

In a case where the cover 109 is closed and the pushing member 107 pushes the push button of the detection part 120, the detection part 120 detects the push of the push button. The opening and closing of the cover 109 is grasped depending on whether or not the push button of the detection part 120 is pushed.

Here, for example, in a case where a cumulative tolerance between the pushing member 107 and the detection part 120 is large, a variation occurs in a positional relationship between the pushing member 107 and the detection part 120, so that a force with which the pushing member 107 pushes the push button of the detection part 120 is not uniform. For this reason, there is a possibility that insufficient push or excessive push may occur. Here, a cumulative tolerance is the accumulation of the tolerances of a plurality of components. For example, there are a method of calculating a cumulative tolerance by simply adding up the tolerances of respective components and a method of calculating a cumulative tolerance on the basis of probability satisfying accumulated tolerances. In the related art, a compression coil spring 141 having elasticity is used to suppress the occurrence of insufficient push or excessive push.

In a case where the compression coil spring 141 is used as shown in FIG. 6, the compression coil spring 141 applies a force in a direction in which the cover 109 is to be opened while the cover 109 is being closed and in a state where the cover 109 has been closed. For this reason, a force required to close the cover 109 may be increased or the closed cover 109 may be opened by a force of the compression coil spring 141.

An image forming apparatus 1 to which the present exemplary embodiment is applied has a configuration for suppressing a reduction in operability in a case where a cover is opened and closed on a housing. The present exemplary embodiment will be described below.

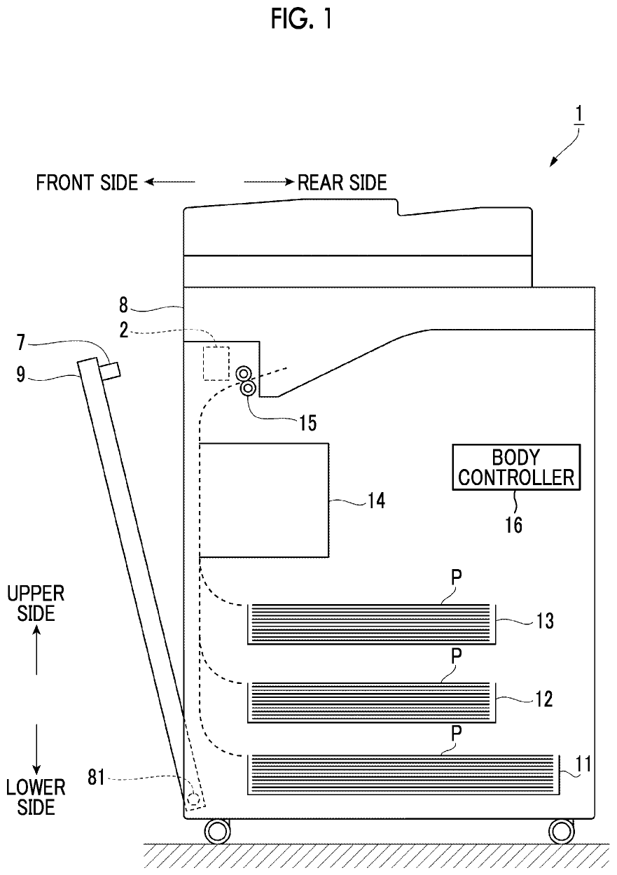

FIG. 1 is a diagram showing an image forming apparatus 1 to which the present exemplary embodiment is applied.

The image forming apparatus 1 shown in FIG. 1 is an apparatus that forms an image on a recording medium, such as a sheet P, using an electrophotographic method or the like. The image forming apparatus 1 according to the present exemplary embodiment is an example of the apparatus.

The image forming apparatus 1 includes a housing 8 that is an exterior covering an outer surface of the image forming apparatus 1, and a cover 9 that can be opened and closed on the housing 8. The housing 8 and the cover 9 are connected to each other via a cover rotating shaft 81 by which the housing 8 and the cover 9 are rotatably connected to each other.

The housing 8 includes a detection unit 2 that detects the opening and closing of the cover 9.

For example, in a case where work inside the apparatus is to be performed, such as a case where a sheet P causes a paper jam on a transport path in the image forming apparatus 1 and a user opens and closes the cover 9 to deal with this paper jam, the cover 9 is opened and closed. Further, the cover 9 includes a pushing member 7 that acts on the detection unit 2. The pushing member 7 is provided at a position facing the detection unit 2 in a case where the cover 9 is closed.

Various devices for forming an image on a sheet P are provided in the housing 8. The image forming apparatus 1 includes sheet storage units 11, 12, and 13 that store sheets P, an image forming unit 14 that forms an image on the sheet P, discharge rollers 15 that discharge the sheet P on which the image is formed, and a body controller 16 that controls the operation of the image forming apparatus 1.

The image forming unit 14 forms an image on the sheet P that is transported from each of the sheet storage units 11, 12, and 13. For example, an electrophotographic method of transferring toner adhered to a photoreceptor to a sheet P to form an image, an ink jet method of jetting ink onto a sheet P to form an image, and the like are employed for the image forming unit 14.

The body controller 16 controls the operation of the image forming apparatus 1. Further, the body controller 16 receives a signal from the detection unit 2, and performs processing corresponding to the received signal. Examples of the processing corresponding to the received signal include a control such as stopping printing in a case where a signal indicating that the cover 9 is opened during printing is received.

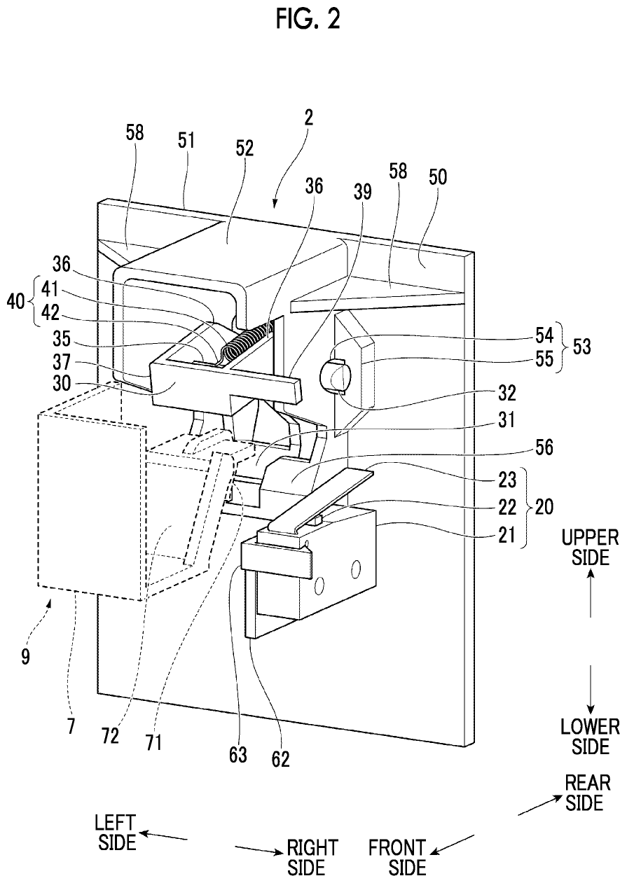

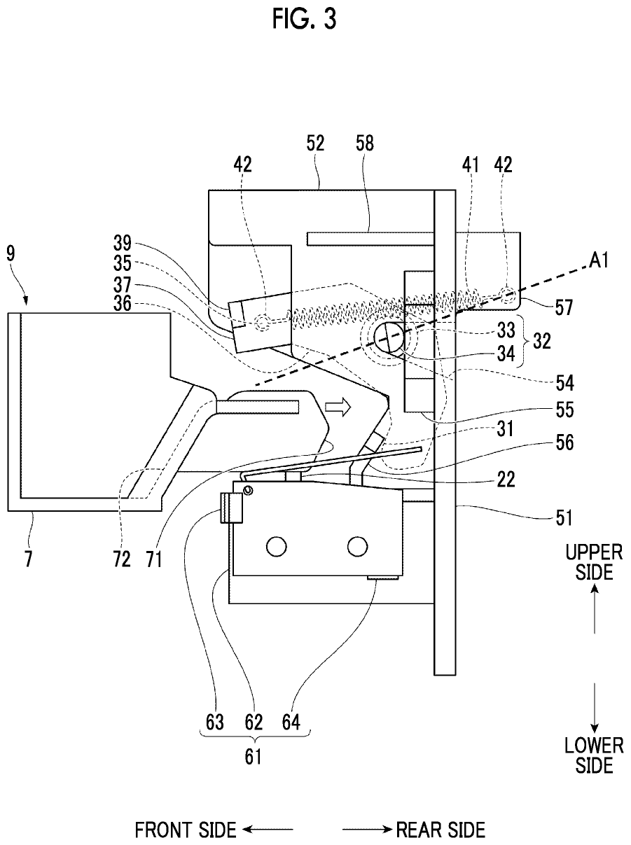

Next, the detection unit 2 (see FIG. 1) and the pushing member 7 will be described with reference to FIGS. 2 and 3.

FIG. 2 is a perspective view illustrating the detection unit 2 and the pushing member 7.

FIG. 3 is a diagram of the detection unit 2 and the pushing member 7 shown in FIG. 2 as viewed from a right side to a left side in FIG. 2.

The detection unit 2 includes a detection part 20 that detects the opening and closing of the cover 9 using ON and OFF of a switch, a rotating part 30 that comes into contact with the detection part 20 to turn on and off the switch of the detection part 20, and a rotation applying part 40 that applies a rotational force to the rotating part 30. Further, the detection unit 2 includes a holding part 50 that holds the detection part 20, the rotating part 30, and the rotation applying part 40.

The detection part 20 includes a detection part body 21 that includes a circuit for detecting ON and OFF, a push button 22 that switches ON and OFF by being pushed down, and an operation arm 23 that assists the push-down of the push button 22.

The detection part body 21 has an outer shape having the shape of a substantially rectangular parallelepiped, and includes an electronic circuit that is provided in the detection part body 21 and detects the push-down of the push button 22. As shown in FIG. 2, the push button 22 and the operation arm 23 are disposed on an upper surface of the detection part body 21. Further, the detection part body 21 includes an inclined surface on the upper surface. This inclined surface is inclined downward toward a rear side. Accordingly, in a case where the operation arm 23 is pushed down, the operation arm 23 and the upper surface of the detection part body 21 do not interfere with each other.

In a case where a force is applied to the push button 22 to the lower side in FIG. 2, the push button 22 is pushed down. In a case where the push button 22 is pushed down, the detection part body 21 sends a signal indicating that the push button 22 is pushed down, that is, a signal indicating that the cover 9 is closed to the body controller 16 (see FIG. 1).

The operation arm 23 is a plate-like member that rises from a front side of the upper surface of the detection part body 21 and extends toward a rear side. A rising portion of the operation arm 23 has elasticity and the operation arm 23 is disposed such that the surface of the operation arm 23 covers the push button 22. Further, the operation arm 23 rises up toward the rear side. The operation arm 23 is disposed at a position intersecting a trajectory along which a switch push-down portion 39 to be described later is moved down.

In a case where the switch push-down portion 39 is moved down, the operation arm 23 is pushed down and pushes down the push button 22 with the surface of the operation arm 23.

The rotating part 30 includes a receiving portion 31 that is to be pushed by a pushing portion 71, rotating shafts 32 that serve as a center of rotation of the rotating part 30, a hook hooking portion 35 on which a hook 42 of the rotation applying part 40 is to be mounted, and a lever 36 that includes the receiving portion 31, the rotating shafts 32, and the hook hooking portion 35. Further, the rotating part 30 includes a pulling portion 37 that pulls in a portion 72 to be pulled, and a switch push-down portion 39 that pushes the push button 22.

As shown in FIGS. 2 and 3, in the present exemplary embodiment, the lever 36 includes two arc-shaped lever portions facing each other and the receiving portion 31 and the hook hooking portion 35 are positioned between the two lever portions. As shown in FIG. 3, the receiving portion 31 is provided on one end side of the lever 36 and the hook hooking portion 35 is provided on the other end side of the lever 36.

The receiving portion 31 receives the pushing portion 71.

The hook hooking portion 35 is a member to which the hook 42 of the rotation applying part 40 is to be hooked.

Each of the rotating shafts 32 has a stepped shape in which a rotating shaft-base portion 33 and a rotating shaft-end portion 34 having outer diameters different from each other are integrally formed, and each of the two lever portions of the lever 36 is provided with the rotating shaft 32. More specifically, in a case where the surfaces of the two lever portions facing each other are defined as inner surfaces, the rotating shafts 32 are provided on outer surfaces that are surfaces opposite to the inner surfaces, respectively. The two rotating shafts 32 are positioned on an identical axis.

More specifically, the rotating shaft-base portion 33 is positioned between the lever portion and the rotating shaft-end portion 34.

The rotating shafts 32 are held by rotating shaft holding portions 53 to be described later. More specifically, the outer diameter of the rotating shaft-base portion 33 is larger than the size of a shaft insertion-cutout portion 54 and the outer diameter of the rotating shaft-end portion 34 is smaller than the size of the shaft insertion-cutout portion 54.

In a case where the rotating part 30 is mounted on the holding part 50, the movement of the rotating shaft-base portions 33 to the left side and the right side of the rotating part 30 is restricted by the holding part 50.

The rotating shaft-end portion 34 has a shape in which a part of an end surface is cut off, so that the rotating shaft-end portion 34 is easily inserted into the rotating shaft holding portion 53.

The pulling portion 37 is provided across the two lever portions of the lever 36 and is positioned close to the hook hooking portion 35 in the present exemplary embodiment. The shape and disposition of the pulling portion 37 are designed in consideration of the position and the like of a member provided on the cover 9.

In the present exemplary embodiment, the switch push-down portion 39 is a rod that is provided to continue from the pulling portion 37 and has the shape of a rectangular parallelepiped extending to the right side in FIG. 2. The switch push-down portion 39 extends up to a region above the push button 22 to push the push button 22 via the operation arm 23 of the detection part 20.

In a case where the cover 9 is closed, the switch push-down portion 39 is moved about the rotating shafts 32 with the rotation of the rotating part 30 and pushes down the push button 22 of the detection part 20. The shape and disposition of the switch push-down portion 39 are designed in consideration of the disposition and the like of the push button 22.

The rotation applying part 40 includes a tension coil spring 41 and hooks 42 that are provided at both ends of the tension coil spring 41 to mount the tension coil spring 41, and applies a rotational force to the rotating part 30. One end of the rotation applying part 40 is mounted on the hook hooking portion 35 of the rotating part 30, and the other end of the rotation applying part 40 is mounted on a hook hooking portion 57 (described later) of the holding part 50. The rotation applying part 40 is an elastic body that is stretched or contracted with the movement of the hook hooking portion 35 and applies to a force to the hook hooking portion 35 in a direction in which the rotation applying part 40 is contracted. For example, a member that extends in a longitudinal direction, is deformed to be stretched depending on a force that pulls both ends of the member in the longitudinal direction, and generates a compressive force depending on the deformation is used as the rotation applying part 40. Examples of the rotation applying part 40 include a tension coil spring, rubber having an elastic force, and the like.

The holding part 50 includes a holding substrate 51 that serves as a base portion of the holding part 50, a rotating part-protective wall 52 that protects the rotating part 30, rotating shaft holding portions 53 that hold the rotating shafts 32 of the rotating part 30, a stopper 56 against which the rotating part 30 butts, a hook hooking portion 57 to which the tension coil spring 41 is to be fixed, reinforcing portions 58 that reinforce the holding part 50, and a switch holding portion 61 that holds the detection part 20.

The rotating part-protective wall 52 covers the rotating part 30 so that the rotating part 30 is not rotated due to an erroneous operation in a case where the cover 9 is opened.

The rotating shaft holding portions 53 that support the rotating shafts 32 to allow the rotating shaft 32 to be rotatable are provided on side surfaces of the rotating part-protective wall 52. Each of the rotating shaft holding portions 53 includes a shaft insertion-cutout portion 54 and a shaft pedestal 55. The shaft insertion-cutout portion 54 is a cutout portion that is formed at a part of the side surface of the rotating part-protective wall 52. Further, the shaft pedestal 55 is provided to cover the shaft insertion-cutout portion 54 in a state where an opening through which the rotating shaft-end portion 34 can pass is left. The shaft pedestal 55 supports the rotating shaft-end portion 34 such that the rotating shaft-end portion 34 inserted into the opening is not moved to the rear side.

The reinforcing portions 58, which are disposed across the rotating part-protective wall 52 and the holding substrate 51, are provided at an upper portion of the rotating part-protective wall 52. The reinforcing portions 58 are right-angled triangular plate-like members, and are provided on the right and left sides of the rotating part-protective wall 52.

The switch holding portion 61 includes a switch holding surface 62 that is in surface-contact with the detection part 20, a switch gripping portion 63 that clamps and fixes the detection part 20, and a switch support portion 64 that supports a lower surface of the detection part 20. The switch holding portion 61 fixes the detection part 20 and positions the detection part 20.

In the detection unit 2 to which the present exemplary embodiment is applied, the detection part 20 and the rotating part 30 are held by the holding part 50. Since the pushing member 7 and the rotating part 30 are connected to each other via at least the cover 9, the tolerance of at least the cover 9 is added to a cumulative tolerance between the pushing member 7 and the rotating part 30. For this reason, a cumulative tolerance between the rotating part 30 and the detection part 20 is smaller than the cumulative tolerance between the pushing member 7 and the rotating part 30. Since the rotating part 30 pushes the push button 22 of the detection part 20, a variation in a force for pushing the push button 22 is small. For this reason, in the detection unit 2 to which the present exemplary embodiment is applied, it is less necessary to reduce a variation in a force for pushing the push button 22 using the compression coil spring 141 described in the related art shown in FIG. 6.

The pushing member 7 of the cover 9 includes a pushing portion 71 and a portion 72 to be pulled.

In a case where the cover 9 is closed, the pushing portion 71 pushes the receiving portion 31 of the rotating part 30 and rotates the rotating part 30 counterclockwise as viewed in a direction perpendicular to the plane of FIG. 3.

In a case where the cover 9 is opened, the portion 72 to be pulled comes into contact with the pulling portion 37 of the rotating part 30 and rotates the rotating part 30 clockwise as viewed in the direction perpendicular to the plane of FIG. 3.

(Action)

Next, a flow of pushing the push button 22 of the detection part 20 in a case where the cover 9 is closed will be described with reference to FIGS. 3, 4, and 5.

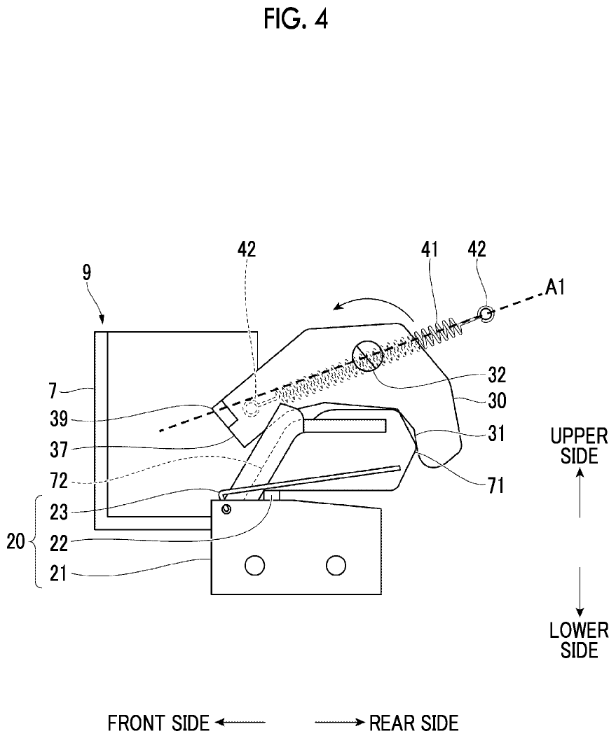

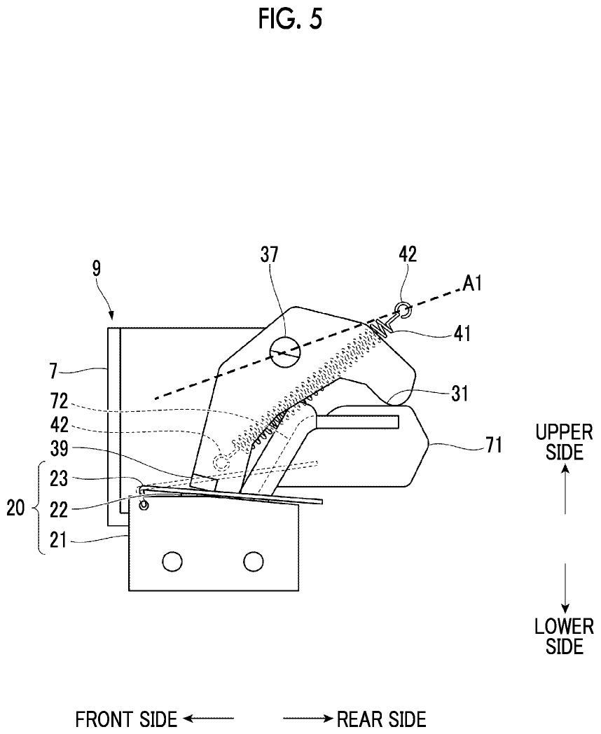

As described above, FIG. 3 is a schematic diagram of the pushing member 7 and the detection unit 2 shown in FIG. 2 as viewed from a right side to a left side in FIG. 2, and FIGS. 4 and 5 are schematic diagrams showing a relationship between the detection part 20, the rotating part 30, the rotation applying part 40, and the pushing member 7. FIGS. 3, 4, and 5 are arranged in chronological order in a case where the cover 9 is closed. A broken line A1 is a straight line that connects the center of the rotating shaft 32 and the hook hooking portion 57, and is a position where the direction of a rotational force applied to the rotating part 30 by the rotation applying part 40 is switched.

In FIG. 3, the rotating part 30 receives a force from the tension coil spring 41. The tension coil spring 41 applies a force to the hook hooking portion 35 of the rotating part 30 in a direction in which the tension coil spring 41 is contracted, that is, a direction from the hook hooking portion 35 toward the hook hooking portion 57. Further, the direction of moment of a force, which is applied to the rotating part 30 by the tension coil spring 41, about the rotating shaft 32 is determined depending on a positional relationship between the rotating shaft 32, the hook hooking portion 35, and the hook hooking portion 57. Hereinafter, the direction of moment of a force, which is applied to the rotating part 30 by the tension coil spring 41, about the rotating shaft 32 is referred to as the direction of a rotational force applied by the tension coil spring 41.

In the present exemplary embodiment, a positional relationship between the position of the rotating shaft 32 and the position of the hook hooking portion 57 is determined by the holding part 50. Accordingly, the direction of a rotational force applied by the tension coil spring 41 is determined depending on the position of the hook hooking portion 35. In a case where the hook hooking portion 35 is positioned below the broken line A1 shown in FIG. 3, the direction of a rotational force applied by the tension coil spring 41 is a counterclockwise direction as viewed in a direction perpendicular to the plane of FIG. 3. On the other hand, in a case where the hook hooking portion 35 is positioned above the broken line A1 shown in FIG. 3, the direction of a rotational force applied by the tension coil spring 41 is a clockwise direction as viewed in a direction perpendicular to the plane of FIG. 3.

The tension coil spring 41 applies a rotational force, which rotates clockwise about the rotating shaft 32, to the rotating part 30. The rotating part 30 receives a clockwise rotational force from the tension coil spring 41, but the receiving portion 31 of the rotating part 30 butts against the stopper 56 of the holding part 50 and the rotating part 30 stops.

Then, in a case where the cover 9 is further closed, the pushing member 7 is moved to the rear side and the pushing portion 71 butts against the receiving portion 31. The rotating part 30 is pushed and rotated counterclockwise by the pushing portion 71 in a state where the pushing portion 71 and the receiving portion 31 are in contact with each other.

In FIG. 4, the tension coil spring 41 is made to be in a most stretched state by the rotating part 30 that is rotated by the pushing portion 71. In this state, a force applied to the rotating part 30 by the tension coil spring 41 is only a force toward the rotating shaft 32 and the rotating part 30 does not receive a rotational force from the tension coil spring 41.

Here, in a case where the pushing member 7 is further moved to the rear side and rotates the rotating part 30 counterclockwise, the direction of a rotational force applied to the rotating part 30 by the tension coil spring 41 is switched and the rotational force is changed into a rotational force acting in a counterclockwise direction about the rotating shaft 32. The rotating part 30 receiving the rotational force in the counterclockwise direction is rotated counterclockwise, the receiving portion 31 is separated from the pushing portion 71, and the pulling portion 37 is in contact with the portion 72 to be pulled.

Then, in a case where the pushing member 7 is moved to the rear side in response to the closing of the cover 9, the surface of the portion 72 to be pulled is also moved to the rear side. As a result, the rotating part 30, which is in contact with the portion 72 to be pulled, is rotated counterclockwise.

Accordingly, the switch push-down portion 39 is moved to the lower side by the force of the tension coil spring 41 and approaches the push button 22 of the detection part 20. In other words, in a case where the cover 9 is closed, the tension coil spring 41 applies a rotational force to the rotating part 30, which is rotated by the pushing member 7, in a direction in which the detection part 20 is turned on.

FIG. 5 shows a state where the cover 9 is closed and the switch push-down portion 39 pushes down the push button 22 of the detection part 20 via the operation arm 23 of the detection part 20.

Since the tension coil spring 41 applies a force for rotating the rotating part 30 counterclockwise to the rotating part 30, the switch push-down portion 39 applies to a downward force to the operation arm 23. In a state where the cover 9 is closed, the pulling portion 37 of the rotating part 30 is separated from the portion 72 to be pulled provided on the cover 9 and the switch push-down portion 39 is in contact with the operation arm 23. In other words, in a case where the rotating part 30 turns on the detection part 20, the pushing member 7 is not in contact with the rotating part 30.

In the present exemplary embodiment, the pushing portion 71 is moved from the front side to the rear side in a case where the cover 9 is closed, and the receiving portion 31 is moved to the upper side as the tension coil spring 41 rotates the rotating part 30 counterclockwise. In other words, in a case where the tension coil spring 41 applies a rotational force in a direction in which the detection part 20 is turned on, the receiving portion 31 is moved in a direction intersecting a direction in which the pushing portion 71 is moved.

Further, the rotating part 30 of the present exemplary embodiment may be adapted to cause the switch push-down portion 39 to come into contact with the operation arm 23 before a direction in which the rotating part 30 is rotated by the tension coil spring 41 is switched.

Supplementary Note

((((1))))

An apparatus comprising:
a housing;
a cover that is opened and closed on the housing;
a detection part that detects opening and closing of the cover using ON and OFF;
a rotating part that is rotatably supported and turns on and off the detection part;
a pushing portion that comes into contact with the rotating part to rotate the rotating part in a case where the cover is closed; and
a rotation applying part that applies a rotational force to the rotating part rotated by the pushing portion in a direction in which the detection part is turned on in a case where the cover is closed.

((((2))))

The apparatus according to (((1))),
wherein a cumulative tolerance between the rotating part, the detection part, and the rotation applying part is smaller than a cumulative tolerance between the pushing portion and the rotating part.

((((3))))

The apparatus according to (((2))),
wherein the detection part, the rotating part, and the rotation applying part are provided in the housing and the pushing portion is provided on the cover.

((((4))))

The apparatus according to (((3))),
wherein the rotation applying part is an elastic body that extends in a longitudinal direction and one end of the elastic body is connected to the rotating part,
the rotating part is rotated about a rotating shaft, and
the detection part, the rotating shaft, and the other end of the elastic body are held by an identical member.

((((5))))

The apparatus according to (((1))),
wherein the rotating part includes a push-down portion that is provided at one end of the rotating part and pushes down the detection part and a receiving portion that is provided at the other end of the rotating part and receives a pushing force from the pushing portion, and
in a case where the push-down portion pushes down the detection part and the detection part is turned on, the pushing portion is not in contact with the receiving portion.

((((6))))

The apparatus according to (((5))),
wherein the receiving portion is moved in a direction intersecting a direction in which the pushing portion is moved, and retreats in a case where the rotation applying part applies the rotational force to the rotating part.

((((7))))

The apparatus according to (((6))),
wherein the detection part includes a push button that is turned on by being pushed down and an operation arm that is elastically deformed to push the push button, and
in a case where the cover is closed, the push-down portion comes into contact with the operation arm before the rotation applying part applies the rotational force to the rotating part in the direction in which the detection part is turned on and pushes the push button via the operation arm after contact between the pushing portion and the receiving portion is released.

((((8))))

The apparatus according to (((1))),
wherein in a case where the rotating part turns on the detection part, the pushing portion is not in contact with the rotating part.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An apparatus comprising:
a housing;
a cover that is opened and closed on the housing;
a detection part that detects opening and closing of the cover using ON and OFF;
a rotating part that is rotatably supported and turns on and off the detection part;
a pushing portion that comes into contact with the rotating part to rotate the rotating part in a case where the cover is closed; and
a rotation applying part that applies a rotational force to the rotating part rotated by the pushing portion in a direction in which the detection part is turned on in a case where the cover is closed.

2. The apparatus according to claim 1,
wherein a cumulative tolerance between the rotating part, the detection part, and the rotation applying part is smaller than a cumulative tolerance between the pushing portion and the rotating part.

3. The apparatus according to claim 2,
wherein the detection part, the rotating part, and the rotation applying part are provided in the housing and the pushing portion is provided on the cover.

4. The apparatus according to claim 3,
wherein the rotation applying part is an elastic body that extends in a longitudinal direction and one end of the elastic body is connected to the rotating part,
the rotating part is rotated about a rotating shaft, and
the detection part, the rotating shaft, and the other end of the elastic body are held by an identical member.

5. The apparatus according to claim 1,
wherein the rotating part includes a push-down portion that is provided at one end of the rotating part and pushes down the detection part and a receiving portion that is provided at the other end of the rotating part and receives a pushing force from the pushing portion, and
in a case where the push-down portion pushes down the detection part and the detection part is turned on, the pushing portion is not in contact with the receiving portion.

6. The apparatus according to claim 5,
wherein the receiving portion is moved in a direction intersecting a direction in which the pushing portion is moved, and retreats in a case where the rotation applying part applies the rotational force to the rotating part.

7. The apparatus according to claim 6,
wherein the detection part includes a push button that is turned on by being pushed down and an operation arm that is elastically deformed to push the push button, and
in a case where the cover is closed, the push-down portion comes into contact with the operation arm before the rotation applying part applies the rotational force to the rotating part in the direction in which the detection part is turned on and pushes the push button via the operation arm after contact between the pushing portion and the receiving portion is released.

8. The apparatus according to claim 1,
wherein in a case where the rotating part turns on the detection part, the pushing portion is not in contact with the rotating part.
